(19) United States
(12) Patent Application Publication
(10) Pub. No.: US 2008/0183968 A1
(43) Pub. Date: Jul. 31, 2008

(54) COMPUTER SYSTEM HAVING CACHE SYSTEM DIRECTLY CONNECTED TO NONVOLATILE STORAGE DEVICE AND METHOD THEREOF

(76) Inventor: Chi-Ting Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/668,471

(22) Filed: Jan. 30, 2007

(51) Int. Cl. G06F 12/08; G06F 12/02; G06F 15/177

(52) U.S. Cl. 711/125; 711/103; 713/2; 711/E12.008; 711/E12.02

(57) ABSTRACT

A computer system includes a nonvolatile memory for storing instructions, a microprocessor, for controlling operation of the computer system, and a cache system coupled to the microprocessor and directly connected to the nonvolatile memory. The cache system is for providing a requested instruction to the microprocessor. If the requested instruction is cached in the cache system, the cache system sends the requested instruction to the microprocessor; otherwise, the cache system retrieves the requested instruction from the nonvolatile memory, caches the requested instruction, and sends the requested instruction to the microprocessor.

### BACKGROUND OF THE INVENTION

1. Field of the Invention

The present invention relates to executing instructions, and more particularly, to a computer system having a cache system directly connected to a nonvolatile storage device, and a method thereof.

2. Description of the Prior Art

An embedded system is a special-purpose system in which the computer system is completely encapsulated by the device it controls. Unlike a general-purpose computer system, such as a personal computer, an embedded system performs one or a few pre-defined tasks, usually with very specific requirements. Sine the system is dedicated to specific tasks, the size and cost of the product can be reduced. For this reason, embedded systems range from portable devices such as MP3 players to large stationary installations like traffic lights or factory controllers.

It is very common to utilize a microprocessor as a control unit in an embedded system. In general, an execution program code, which is executed by the microprocessor, is stored in an inner nonvolatile storage device such as a read only memory (ROM). ROMs allow data to be written into them at least once; therefore, the accuracy of the execution program code is very important during initial code programming. It is necessary, however, to replace or correct the execution program code when developing a new ROM-based embedded system. Even though the data stored in some kinds of ROMs can be changed, the cost is high and requires a lot of time to program the ROM codes.

### SUMMARY OF THE INVENTION

It is therefore one of the objectives of the present invention to provide a computer system and related method for storing an execution program code in an outer nonvolatile storage device (e.g. a serial flash) instead of the inner nonvolatile storage device (ROM). The execution program code saved in the outer nonvolatile storage device can be modified or changed easily, thereby solving the above-mentioned problem.

According to an exemplary embodiment of the claimed invention, a computer system is disclosed. The computer system comprises a nonvolatile memory, a microprocessor, and a cache system. The nonvolatile memory is for storing instructions. The microprocessor is for controlling operation of the computer system. The cache system is coupled to the microprocessor and directly connected to the nonvolatile memory, for providing a requested instruction to the microprocessor, wherein if the requested instruction is cached in the cache system, the cache system sends the requested instruction to the microprocessor; otherwise, the cache system retrieves the requested instruction from the nonvolatile memory, caches the requested instruction, and then sends the requested instruction to the microprocessor.

According to another exemplary embodiment of the claimed invention, a method of retrieving instructions is disclosed. The method comprises: directly connecting a nonvolatile memory and a cache system, wherein the nonvolatile memory stores instructions; requesting the cache system for a requested instruction; and if the requested instruction is cached in the cache system, utilizing the cache system to output the requested instruction for execution; otherwise, utilizing the cache system to retrieve the requested instruction from the nonvolatile memory, cache the requested instruction, and then output the requested instruction for execution.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a computer system according to an embodiment of the present invention.

FIG. 2 is a flow chart illustrating operation of the computer system shown in FIG. 1 running a booting process.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

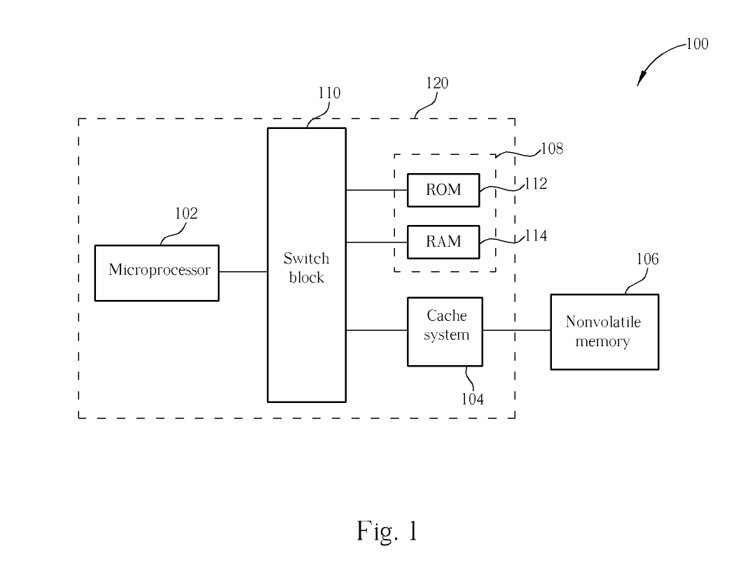

Please refer to FIG. 1. FIG. 1 is a block diagram illustrating a computer system 100 according to an embodiment of the present invention. In this embodiment, the computer system 100 is an embedded system configured to handle specific tasks; however, this is not meant to be a limitation of the present invention. As shown in FIG. 1, the computer system 100 comprises, but is not limited to, a microprocessor 102 (e.g. an 8051-based processor), a cache system 104, and a nonvolatile memory 106. The nonvolatile memory 106 is implemented for storing instructions. The microprocessor 102 is implemented for controlling operation of the computer system 100 by executing pre-defined instructions. The cache system 104 is coupled to the microprocessor 102 and directly connected to the nonvolatile memory 106, and is implemented for providing a requested instruction to the microprocessor 102 when a “cache hit” occurs. In this embodiment, the nonvolatile memory 106 is implemented by a serial flash; however, this example is merely for illustrative purposes, and is not meant to be a limitation of the present invention.

If the requested instruction has been cached in the cache system 104, the cache system 104 can send the requested instruction to the microprocessor 102 at once to allow the microprocessor 102 to execute the requested instruction. If the cache system 104 cannot retrieve the requested instruction, however, a “cache miss” occurs. In this case, the cache system 104 will retrieve the requested instruction from the nonvolatile memory 106 (e.g. a serial flash), cache the requested instruction, and then send the requested instruction to the microprocessor 102 for execution. The cache system 104 can be designed to adopt any conventional cache policy, such as write back, critical word first, early restart, or nonblocking. Since the detailed operation of the above-identified conventional cache policies are well known to those skilled in this art, further description is omitted here for the sake of brevity. It should be noted that the above-mentioned cache policy is for illustrative purpose only and is not meant to be taken as a limitation of the present invention.

Briefly summarized, the computer system 100 utilizes the cache system 104 to buffer the instructions cached from the nonvolatile memory 106 (e.g. a serial flash) so as to improve the low data transmission rate of the serial flash compared to that of the typical ROM. Furthermore, the cache system 104 is directly connected to the serial flash 106; that is, unlike the personal computer system, there is no extra component such as a dynamic random access memory (DRAM) connected between the cache system 104 and the serial flash 106. Accordingly, with the help of the cache system 104, the performance of executing instructions retrieved from the serial flash 106 is comparable to the performance of executing instructions retrieved from the typical ROM.

Please refer to FIG. 1 again. As shown in FIG. 1, the computer system 100 further comprises a storage device 108 and a switch block 110; in addition, the microprocessor 102, the cache system 104, the storage device 108, and the switch block 110 are positioned in a single chip 120 (e.g. the same IC), and the nonvolatile memory 106 (e.g. a serial flash) is an external component of the single chip 120. The internal storage device 108 is implemented for storing instructions. The switch block 110 is coupled to the storage device 108, the cache system 104 and the microprocessor 102, and is implemented for selectively allowing the storage device 108 or the cache system 104 to send a requested instruction to the microprocessor 102. In this embodiment, the storage device 108 comprises a read only memory (ROM) 112 and a random access memory (RAM) 114. The ROM 112 is implemented for storing pre-defined instructions. In other words, the microprocessor 102 can fetch the pre-defined instructions in the ROM 112 and then execute the fetched instructions to perform the specified functionality of the computer system 100 (e.g. an embedded system). The RAM 114 is implemented for buffering requested instructions, such as booting instructions, received from the ROM 112 or the nonvolatile memory 106 (e.g. a serial flash). In the following description, the requested instructions are booting instructions, and the switch block 110 is configured to select the source of the booting instructions, for example, according to a boot selection received at one I/O pin of the single chip 120; however, this should not be taken as a limitation of the present invention. Further description of the computer system 100 running a booting process is as follows.

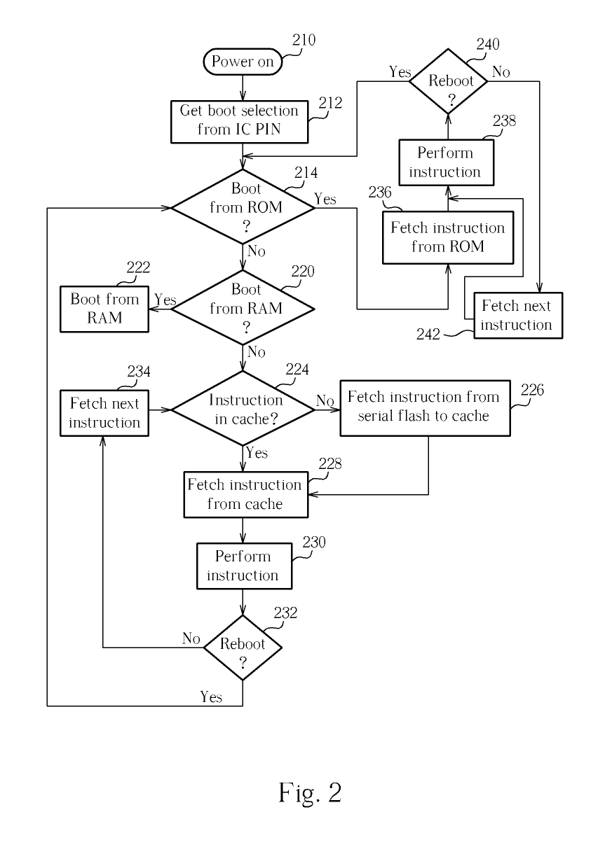

Please refer to FIG. 2. FIG. 2 is a flow chart illustrating operation of the computer system 100 running a booting process according to an exemplary embodiment of the present invention. When powering on the computer system 100 (step 210), the computer system 100 will receive a boot selection received from an I/O pin of the single chip 120 (step 212). The booting selection determines whether the computer system 100 will boot from the ROM 112 or the nonvolatile memory 106 (e.g. a serial flash); i.e. the booting selection defines the source of instructions to be executed by the microprocessor 102. The microprocessor 102 therefore first refers to the boot selection to know whether the computer system 100 should be booted by executing booting instructions stored in the ROM 112 (step 214). If the booting selection indicates the microprocessor 102 should execute booting instructions stored in the ROM 112, the computer system 100 boots from the ROM 112 through the switch block 110. The microprocessor 102 fetches an instruction from the ROM 112, and then executes it (steps 236 and 238). If the booting instructions stored in the ROM 112 have pre-defined specific instructions configured to enable booting from the RAM 114, the microprocessor 102 will be instructed to reboot (step 240). However, before the microprocessor 102 is rebooted, the microprocessor 102 executes the above specific instructions to load the booting instructions stored in the ROM 112 to the RAM 114, and sets the RAM 114 as the resource of instructions to be executed after the microprocessor 112 reboots through steps 238 and 242. After the microprocessor 112 has been rebooted due to the instruction execution (step 240), the microprocessor 112 refers to the source of instructions set by the instruction execution for executing the booting instructions loaded from the ROM 108. In other words, the computer system 100 boots from the RAM 114 (step 222) through the switch block 110. However, as shown in FIG. 2, if the booting instructions stored in the ROM 112 do not have pre-defined specific instructions configured to enable booting from the RAM 114, the microprocessor 102 will not be rebooted and steps 238 and 242 are repeated continuously until the booting sequence is completed.

As shown in FIG. 2, if the booting selection defines that the microprocessor 102 should execute booting instructions stored in the nonvolatile memory 106 (i.e. a serial flash), the switch block 110 allows the microprocessor 102 to execute the booting instruction fetched from the cache system 104 (steps 224, 228, 230, and 234; step 226 is executed when a “cache miss” occurs). Similarly, if the booting instructions stored in the nonvolatile memory 106 have pre-defined specific instructions configured to enable booting from the RAM 114, the microprocessor 102 will be instructed to reboot (step 232). However, before the microprocessor 102 is rebooted, the microprocessor 102 executes the above specific instructions to load the booting instructions stored in the nonvolatile memory 106 to the RAM 114, and sets the RAM 114 as the source of instructions to be executed after the microprocessor 112 reboots through steps 230 and 232. After the microprocessor 112 has been rebooted due to the instruction execution (step 232), the microprocessor 112 refers to the source of instructions set by the instruction execution for executing the booting instructions loaded from the nonvolatile memory 106. In other words, the computer system 100 boots from the RAM 114 (step 222) through the switch block 110. However, as shown in FIG. 2, if the booting instructions stored in the nonvolatile memory 106 do not have pre-defined specific instructions configured to enable booting from the RAM 114, the microprocessor 102 will not be rebooted and steps 224, 228, 230, and 234 (step 226 is executed when a “cache miss” occurs) are repeated continuously until the booting sequence is completed. Since the operation of the cache system 104 has been detailed above, further description is omitted here for the sake of brevity.

As mentioned above, the cache system 104 is implemented to boost performance of executing instructions from the external nonvolatile memory 106. Therefore, when executing booting instructions from the ROM 112 and the nonvolatile memory 106 if the booting option from the RAM 114 is not selected, the time required for completing the booting sequence by executing booting instructions stored in the nonvolatile memory 106 through the cache system 104 is comparable to that required for booting from the ROM 112. Please note that this example is not meant to limit the scope of the present invention.

Briefly summarized, the computer system 100 (e.g. an embedded system) is able to boot from either the ROM 112 or the nonvolatile memory 106 (e.g. a serial flash); wherein both can be further divided into two booting modes; directly booting from the selected storage device, or booting from the RAM 114 in which the booting instruction received from the selected storage device is buffered. Accordingly, when there are bugs in the originally programmed booting instructions stored in the ROM 112, corrected booting instructions can be stored in the external nonvolatile memory 106, and the computer system 100 can boot according to these corrected booting instructions so the computer system 100 will operate as desired. In an exemplary embodiment of the present invention, utilizing an external serial flash to serve as an instruction source is a cost efficient solution to the ROM-based embedded system having corrupted ROM codes problem. Additionally, other instructions can also be stored in the nonvolatile memory 106 so as to expand the functions of the computer system 100. This also obeys the spirit of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system, comprising:
a nonvolatile memory, for storing instructions;
a microprocessor, for controlling operation of the computer system; and
a cache system, coupled to the microprocessor and directly connected to the nonvolatile memory, for providing a requested instruction to the microprocessor, wherein if the requested instruction is cached in the cache system, the cache system sends the requested instruction to the microprocessor; otherwise, the cache system retrieves the requested instruction from the nonvolatile memory, caches the requested instruction, and sends the requested instruction to the microprocessor.

2. The computer system of claim 1, further comprising:
a storage device, for storing instructions; and
a switch block, coupled to the storage device, the cache system and the microprocessor, for selectively allowing the storage device or the cache system to send the requested instruction to the microprocessor.

3. The computer system of claim 2, wherein the storage device comprises a read only memory (ROM) for storing instructions.

4. The computer system of claim 3, wherein the nonvolatile memory is a serial flash.

5. The computer system of claim 4, wherein the requested instruction includes a booting instruction.

6. The computer system of claim 5, wherein the storage device further comprises:
a random access memory (RAM), for buffering the booting instruction received from the ROM or the serial flash;
wherein the switch block selectively allows the ROM, the serial flash, or the RAM to send the booting instruction to the microprocessor.

7. The computer system of claim 2, wherein the microprocessor, the cache system, the storage device, and the switch block are positioned in a single chip, and the nonvolatile memory is an external component of the single chip.

8. The computer system of claim 1, wherein the nonvolatile memory is a serial flash.

9. The computer system of claim 1, wherein the requested instruction includes a booting instruction.

10. The computer system of claim 1, wherein the microprocessor and the cache system are positioned in a single chip, and the nonvolatile memory is an external component of the single chip.

11. A method of retrieving instructions, comprising:
directly connecting a nonvolatile memory and a cache system, wherein the nonvolatile memory stores instructions;
requesting the cache system for a requested instruction; and
if the requested instruction is cached in the cache system, utilizing the cache system to output the requested instruction for execution; otherwise, utilizing the cache system to retrieve the requested instruction from the nonvolatile memory, cache the requested instruction, and output the requested instruction for execution.

12. The method of claim 11, further comprising:
providing a storage device for storing instructions; and
selectively allowing the storage device or the cache system to output the requested instruction for execution.

13. The method of claim 12, wherein the step of providing the storage device comprises utilizing a read only memory (ROM) in the storage device for storing instructions.

14. The method of claim 13, wherein the nonvolatile memory is a serial flash.

15. The method of claim 14, wherein the requested instruction includes a booting instruction.

16. The method of claim 15, wherein the step of providing the storage device further comprises utilizing a random access memory (RAM) for buffering the booting instruction received from the ROM or the serial flash; and the step of selectively allowing the storage device or the cache system to output the requested instruction for execution comprises selectively allowing the ROM, the serial flash, or the RAM to output the booting instruction for execution.

17. The method of claim 11, wherein the nonvolatile memory is a serial flash.

18. The method of claim 11, wherein the requested instruction includes a booting instruction.
